(19) United States
(12) Patent Application Publication
(10) Pub. No.: US 2010/0169828 A1
(43) Pub. Date: Jul. 1, 2010

(54) COMPUTER DESKTOP ORGANIZATION VIA MAGNET ICONS

(75) Inventors: Nancy E. Kho, Belmont, MA (US); Fang Lu, Billerica, MA (US)

Correspondence Address: CAREY, RODRIGUEZ, GREENBERG & PAUL, LLP;STEVEN M. GREENBERG, 950 PENINSULA CORPORATE CIRCLE, SUITE 2022, BOCA RATON, FL, 33487, US

(73) Assignee: INTERNATIONAL BUSINESS MACHINES CORPORATION, Armonk, NY (US)

(21) Appl. No.: 12/345,206

(22) Filed: Dec. 29, 2008

(51) Int. Cl. G06F 3/048

(52) U.S. Cl. 715/810

(57) ABSTRACT

Embodiments of the present invention provide a method, system and computer program product for computer desktop organization via magnet icons. In an embodiment of the invention, a method for computer desktop organization via magnet icons can include creating a magnet icon and placing the magnet icon on a graphical user interface (GUI) desktop. The method also includes selecting an object attribute for the magnet icon and filtering icons on the GUI desktop according to the object attribute. Finally, the method includes moving the filtered icons in proximity to the magnet icon on the GUI desktop. In one aspect of the embodiment, the method further includes receiving an operation to be applied to the magnet icon and concurrently applying the operation to the filtered icons in proximity to the magnet icon.

### BACKGROUND OF THE INVENTION

1. Field of the Invention

The present invention relates to the field of graphical user interface management (GUI) and more particularly to computer desktop organization for personal computing.

2. Description of the Related Art

The conventional GUI has been widely used for many years. The primary function of the GUI includes providing user interface controls with which the end user can interact with an underlying application. The computer desktop provides the primary GUI for an operating system through which end users can access files and applications. The desktop paradigm, a staple of personal computing for decades, emulates the appearance of the desk workspace utilizing an arrangement of stock GUI controls. Generally, the GUI desktop includes a menu bar providing different menu options for manipulating the appearance of the desktop and also for accessing documents, folders and applications present in or accessible through the desktop. The GUI desktop also includes a series of icons representative of underlying documents, folders and applications. Activating a given icon on the GUI desktop by default can result in the launching of an underlying program, the viewing of an underlying document in an associated application or the viewing of the contents of an underlying folder.

The versatility of the GUI desktop in providing ease of access to documents, folders and applications is not without consequence. For many users, the GUI desktop can become as cluttered if not more cluttered than a traditional desk workspace. To facilitate the problem of GUI desktop clutter, oftentimes end users group collections of icons in folders. By default, many GUI driven operating systems provide icon arrangement functionality through the menu bar of the desktop or through a context menu for the desktop. Traditional “arrange” or “clean up” operations sort icons on a desktop by representative object type, by alphabetical ordering, or by date of creation, to name a few modes of icon arrangement. Further icon arrangement can be performed only a selected set of icons, or on the entirety of icons present in the GUI desktop.

Even still, icons quickly can become displaced in the GUI desktop through the ordinary use of the desktop and clutter remains. Further, icons can become stale or delinked from no longer existent underlying objects. Recently, GUI driven operating systems have provided an automated facility to remind end users to “clean up” the desktop. Notwithstanding, such automated facilities largely relate to the removal of stale icons or icons with broken links to no longer existent or renamed underlying objects. End users require more intelligence in GUI desktop management to avoid clutter and to maintain sensibility in how icons are arranged on the GUI desktop.

### BRIEF SUMMARY OF THE INVENTION

Embodiments of the present invention address deficiencies of the art in respect to icon management in a GUI desktop and provide a novel and non-obvious method, system and computer program product for computer desktop organization via magnet icons. In an embodiment of the invention, a method for computer desktop organization via magnet icons can include creating a magnet icon and placing the magnet icon on a GUI desktop. The method also includes selecting an object attribute for the magnet icon and filtering icons on the GUI desktop according to the object attribute. Finally, the method includes moving the filtered icons in proximity to the magnet icon on the GUI desktop. In one aspect of the embodiment, the method further includes receiving an operation to be applied to the magnet icon and concurrently applying the operation to the filtered icons in proximity to the magnet icon.

In another embodiment of the invention, a personal computing data processing system can be configured for computer desktop organization via magnet icons. The system can include a personal computer and an operating system executing in the personal computer and providing a GUI desktop. The system further can include icons rendered in the GUI desktop and a magnet module coupled to the GUI desktop. The module can include program code enabled to create a magnet icon and to place the magnet icon on the GUI desktop, to select an object attribute for the magnet icon, to filtering the icons according to the object attribute, and to move the filtered icons in proximity to the magnet icon on the GUI desktop.

In one aspect of the embodiment, the object attribute can include an object attribute such as an object name, a partial object name, an object type, an object creation date and an object last accessed date. In another aspect of the embodiment, the magnet icon can be an anchor species of a magnet icon.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a GUI desktop configured for computer desktop organization via magnet icons;

FIG. 2 is a schematic illustration of a personal computing data processing system configured for computer desktop organization via magnet icons; and,

FIG. 3 is a flow chart illustrating a process for computer desktop organization via magnet icons.

### DETAILED DESCRIPTION OF THE INVENTION

Embodiments of the present invention provide a method, system and computer program product for computer desktop organization via magnet icons. In accordance with an embodiment of the present invention, a magnet icon can be created and placed on the GUI desktop. The magnet icon can specify one or more filtering attributes of objects referenced by icons on the GUI desktop. Thereafter, icons on the GUI desktop can be selected according to the filtering attributes and arranged in proximity to the magnet icon. Operations performed on the magnet icon can be concurrently applied to the selected icons arranged in proximity to the magnet icon including a move operation. Optionally, the magnet icon can be an anchor icon species of the magnet icon specifying one or more objects referenced by icons on the GUI desktop. As in the case of the magnet icon, icons on the GUI desktop can be selected as specified in the anchor icon and arranged in proximity to the anchor icon. Operations performed on the anchor icon can be concurrently applied to the selected icons arranged in proximity to the anchor icon including a move operation.

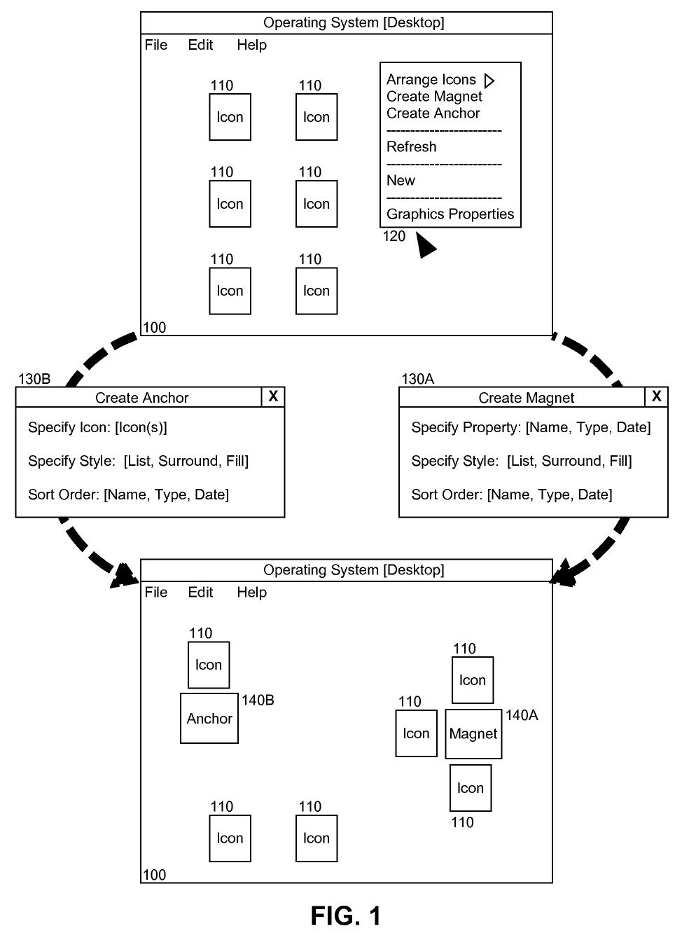

In further illustration, FIG. 1 pictorially depicts a GUI desktop configured for computer desktop organization via magnet icons. As shown in FIG. 1, a GUI desktop 100 can include multiple different icons 110, each representative of an underlying object such as a file, folder or application. A context menu 120 can be provided to access a directive to arrange the icons 110 in the GUI desktop 100, a directive to create a magnet icon in the GUI desktop 100 for one or more of the icons 110, and a directive to create an anchor icon species of a magnet icon in the GUI desktop 100 for one or more of the icons 110.

In response to the activation of the directive to create a magnet icon in the context menu 120, a dialog box 130A can be rendered to permit the specification of icon attributes relating to the underlying objects referenced by the icons 110. The attributes can include a particular object property such as a partial or complete name or a string of characters present in a name for an underlying object referenced by individual ones of the icons 110, a type of underlying object referenced by individual ones of the icons 110, or a date of creation or last access of an underlying object referenced by individual ones of the icons 110. The dialog box 130A also can be rendered to permit a selection of arrangement style for individual ones of the icons 110 such as a list style, a surround style or an area fill style. Finally, the dialog box 130A can be rendered to permit a selection of a sorting order for individual ones of the icons 110, such as alphabetically by name, creation or last accessed date or object type.

Once each of the attributes, style and sort order have been selected, a magnet icon 140A can be created in the GUI desktop 100. Individual ones of the icons 110 referencing underlying objects matching the selected attributes of the magnet icon 140A can be moved into proximity of the magnet icon 140A and arranged according to the selected arrangement style (shown to be “surround” in FIG. 1). The arrangement style can be a sequential listing of the individual ones of the icons 110 in proximity to the magnet icon 140A, a surrounding of the magnet icon 140A with the individual ones of the icons 110, or the filling of a designated area of the GUI desktop 100 with the magnet icon 140A and the individual ones of the icons 110. Further, the sort order applied to the individual ones of the icons 110 moved in proximity to the magnet icon 140A can be dictated according to the sort order specified for the magnet icon 140A. Thereafter, operations performed on the magnet icon 140A can be equally applied to the individual ones of the icons 110 moved in proximity to the magnet icon 140A, including any movement of the magnet icon 140A about the GUI desktop 100, the deletion of the magnet icon 140A from the GUI desktop 100, the copying of the magnet icon 140A in the GUI desktop 100 and the like.

By comparison, in response to the activation of the directive to create an anchor icon species of a magnet icon in the context menu 120, a dialog box 130B can be rendered to permit the specification of object names of the underlying objects referenced by the icons 110. The dialog box 130B also can be rendered to permit a selection of arrangement style for individual ones of the icons 110 such as a list style, a surround style or an area fill style. Finally, the dialog box 130B can be rendered to permit a selection of a sorting order for individual ones of the icons 110, such as alphabetically by name, creation or last accessed date or object type.

Once each of the object names, style and sort order have been selected, an anchor icon 140B can be created in the GUI desktop 100. Individual ones of the icons 110 referencing the underlying objects matching the specified object names of the anchor icon 140B can be moved into proximity of the anchor icon 140B and arranged according to the selected arrangement style. Further, the sort order applied to the individual ones of the icons 110 moved in proximity to the anchor icon 140B can be dictated according to the sort order specified for the anchor icon 140B. Thereafter, operations performed on the anchor icon 140B can be equally applied to the individual ones of the icons 110 moved in proximity to the anchor icon 140B, including any movement of the anchor icon 140B about the GUI desktop 100, the deletion of the anchor icon 140B from the GUI desktop 100, the copying of the anchor icon 140B in the GUI desktop 100 and the like.

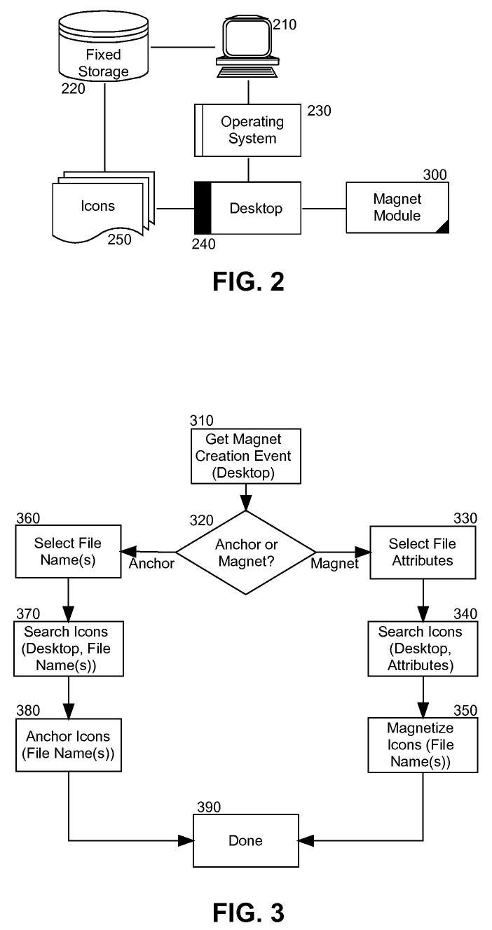

The process described in connection with FIG. 1 can be implemented within a personal computing data processing system. In further illustration, FIG. 2 schematically shows a personal computing data processing system configured for computer desktop organization via magnet icons. The system can include a host computing system 210 such as a personal computer including fixed storage 220 and supporting the operation of an operating system 230. The operating system 230 can include a GUI desktop 240 as an end user operating environment in which multiple different icons 250 can be placed to provide access to underlying objects in fixed storage (or possibly disposed elsewhere such as over a computer communications network) referenced by respective ones of the icons 250.

Notably, a magnet module 300 can be coupled to the desktop 240. The magnet module 300 can include program code enabled to create and place a magnet icon on the GUI desktop 240. The magnet icon can specify one or more filtering attributes of objects referenced by icons 250 on the GUI desktop 240. Thereafter, icons 250 on the GUI desktop 240 can be selected according to the filtering attributes and arranged in proximity to the magnet icon. Operations performed on the magnet icon can be concurrently applied to the selected ones of the icons 250 arranged in proximity to the magnet icon. Optionally, an anchor icon species of a magnet icon can be created and placed on the GUI desktop 240. The anchor icon can specify one or more objects referenced by icons 250 on the GUI desktop 240 and, as in the case of the magnet icon, individual ones of the icons 250 on the GUI desktop 240 can be selected as specified in the anchor icon and arranged in proximity to the anchor icon. Operations performed on the anchor icon can be concurrently applied to the selected ones of the icons 250 arranged in proximity to the anchor icon.

Of note, the program code of the magnet module 300 can be enabled to produce one or more magnet icons pre-configured to apply to selected ones of the icons 250, such as by pre-configured object attributes such as newly created files, picture files, word processing files, files of a particular size, and the like. Alternatively, the program code of the magnet module 300 can be enabled to inspect the content of the underlying objects of the icons 250 in order to identify associations with specified object attributes, for example by matching text within the content to specified object attributes. Examples include matching text within the content to a specified term describing a common association amongst files such as project type, or customer name. Even yet further, the program code of the magnet module 300 can be enabled to produce one or more magnet icons pre-configured to apply to selected ones of the icons 250 according to historically observed behavior with respect to the icons 250 such as icons 250 that are selected in close temporal proximity to one another, or icons 250 activated to access underlying objects in close temporal proximity to one another.

In yet further illustration of the operation of the magnet module 300, FIG. 3 is a flow chart illustrating a process for computer desktop organization via magnet icons. Beginning in block 310, a magnet creation event can be received in an event handler for the GUI desktop, for instance through a context menu event loop. In decision block 320, it can be determined whether the magnet creation event directs the creation of an anchor icon species of the magnet icon. In the case of a magnet icon, in block 330 one or more object attributes can be selected, such as object name or partial object name, object type, object creation date or object last accessed date. Thereafter, in block 340 icons on the desktop can be filtered according to whether or not respectively referenced underlying objects match the selected attributes. Finally, in block 350 a magnet icon can be placed onto the GUI desktop and the filtered icons can be moved into proximity of the magnet icon. Further, the GUI desktop can be configured to concurrently apply operations for the magnet icon upon the filtered icons.

Returning now to decision block 320, in the case of an anchor icon species of a magnet icon, in block 360 one or more object names can be selected. Thereafter, in block 370 icons on the desktop can be filtered according to whether or not respectively referenced underlying objects match the selected object names. Finally, in block 380 an anchor icon can be placed onto the GUI desktop and the filtered icons can be moved into proximity of the anchor icon. Further, the GUI desktop can be configured to concurrently apply operations for the anchor icon upon the filtered icons. The process can end in block 390.

Of note, while embodiments of the invention have been described in connection with placing a magnet icon on a GUI desktop, the skilled artisan will recognize the utility of placing a magnet icon in a folder accessible through a GUI desktop. In this way, icons in the folder can be organized about the magnet icon in the same way icons on the GUI desktop can be organized about a magnet icon disposed on the GUI desktop.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. In a graphical user interface (GUI) desktop, a method for computer desktop organization via magnet icons, the method comprising:
creating a magnet icon and placing the magnet icon on the GUI desktop;
selecting an object attribute for the magnet icon;
filtering icons on the GUI desktop according to the object attribute; and,
moving the filtered icons in proximity to the magnet icon on the GUI desktop.

2. The method of claim 1, wherein selecting an object attribute for the magnet icon comprises, pre-configuring the magnet icon for a specific object attribute.

3. The method of claim 1, further comprising:
receiving an operation to be applied to the magnet icon; and,
concurrently applying the operation to the filtered icons in proximity to the magnet icon.

4. The method of claim 3, wherein concurrently applying the operation to the filtered icons in proximity to the magnet icon, comprises moving the filtered icons in proximity to the magnet icon concurrently and in concert with the magnet icon in response to an operation to move the magnet icon in the GUI desktop.

5. The method of claim 1, wherein the object attribute comprises an attribute selected from the group consisting of an object name, a partial object name, an object type, an object creation date and an object last accessed date.

6. The method of claim 1, wherein creating a magnet icon and placing the magnet icon on the GUI desktop, comprises creating an anchor icon species of a magnet icon and placing the anchor icon on the GUI desktop.

7. A personal computing data processing system configured for computer desktop organization via magnet icons, the system comprising:
a personal computer;
an operating system executing in the personal computer and providing a graphical user interface (GUI) desktop;
a plurality of icons rendered in the GUI desktop; and,
a magnet module coupled to the GUI desktop, the module comprising program code enabled to create a magnet icon and to place the magnet icon on the GUI desktop, to select an object attribute for the magnet icon, to filtering the icons according to the object attribute, and to move the filtered icons in proximity to the magnet icon on the GUI desktop.

8. The system of claim 7, wherein the object attribute comprises an object attribute selected from the group consisting of an object name, a partial object name, an object type, an object creation date and an object last accessed date.

9. The system of claim 7, wherein the magnet icon is an anchor species of a magnet icon.

10. A computer program product comprising a computer usable medium embodying computer usable program code for computer desktop organization via magnet icons, the computer program product comprising:
computer usable program code for creating a magnet icon and placing the magnet icon on a graphical user interface (GUI) desktop;
computer usable program code for selecting an object attribute for the magnet icon;
computer usable program code for filtering icons on the GUI desktop according to the object attribute; and,
computer usable program code for moving the filtered icons in proximity to the magnet icon on the GUI desktop.

11. The computer program product of claim 10, wherein the computer usable program code for selecting an object attribute for the magnet icon comprises, computer usable program code for pre-configuring the magnet icon for a specific object attribute.

12. The computer program product of claim 10, further comprising:
computer usable program code for receiving an operation to be applied to the magnet icon; and,
computer usable program code for concurrently applying the operation to the filtered icons in proximity to the magnet icon.

13. The computer program product of claim 12, wherein the computer usable program code for concurrently applying the operation to the filtered icons in proximity to the magnet icon, comprises computer usable program code for moving the filtered icons in proximity to the magnet icon concurrently and in concert with the magnet icon in response to an operation to move the magnet icon in the GUI desktop.

14. The computer program product of claim 10, wherein the object attribute comprises an attribute selected from the group consisting of an object name, a partial object name, an object type, an object creation date and an object last accessed date.

15. The computer program product of claim 10, wherein the computer usable program code for creating a magnet icon and placing the magnet icon on the GUI desktop, comprises computer usable program code for creating an anchor icon species of a magnet icon and placing the anchor icon on the GUI desktop.
